(19) United States
(12) Patent Application Publication
(10) Pub. No.: US 2011/0305550 A1
(43) Pub. Date: Dec. 15, 2011

(54) MOTOR VEHICLE CONFIGURED FOR CARGO TRANSPORT AND VEHICLE-MOUNTABLE CARGO TRANSPORT APPARATUS

(76) Inventor: Andrew Ralph Haire, Thomasville, NC (US)

(21) Appl. No.: 12/797,961

(22) Filed: Jun. 10, 2010

(51) Int. Cl. B60P 1/44; B60P 1/02; B60S 9/02

(52) U.S. Cl. 414/495; 414/545; 414/812

(57) ABSTRACT

A vehicle-mountable cargo transport apparatus configured for association with a motor vehicle so that the motor vehicle has a gross vehicle weight rating (GVWR) up to about 10,000 lbs and may be capable of transporting a cargo up to about 3,500 lbs or more and a motor vehicle including a vehicle-mountable cargo transport apparatus are disclosed. The motor vehicle includes a chassis cab or cutaway chassis and the vehicle-mountable cargo transport apparatus. The vehicle-mountable cargo transport apparatus includes a cargo-carrying unit and an extensible spacer mechanism. The extensible spacer mechanism is configured for reversibly increasing a distance of the cargo-carrying unit with respect to the ground so as to accommodate at least one of receiving and delivering a cargo at a conventional loading dock. The cargo-carrying unit is configured for at least one of receiving and delivering a cargo at a conventional loading dock; at least the other of receiving and delivering the cargo at street level, and securing the cargo to maintain the cargo's integrity for delivery.

### BACKGROUND

The present invention is directed to a motor vehicle configured for cargo transport, such as a box truck, a vehicle-mountable cargo transport apparatus including cargo-carrying unit for use in connection with a motor vehicle, such as a chassis cab or cutaway chassis. The vehicle-mountable cargo transport apparatus enables adjustment of the height of a cargo-carrying unit with respect to the ground, for example by adjustment of the height of a cargo-carrying unit with respect to the chassis cab or cutaway chassis, so as to accommodate at least one of receiving and delivering a cargo at a conventional loading dock. Optionally, the vehicle-mountable cargo transport apparatus enables an adjustment of the position of the cargo-carrying unit door to facilitate the loading and unloading of cargo.

Trucks are used for transporting goods and materials, and are manufactured in a variety of sizes ranging from small pickup trucks to large commercial trucks, such as semi-trailers. In the United States, truck classification is determined based on the vehicle's gross vehicle weight rating (GVWR). Federal and state statutes and regulations in the United States utilize GVWR as one of the factors for imposing certain requirements on truck operators, ranging from when the operator is required to obtain a commercial driver's license (CDL), to safety and emissions inspections, to insurance requirements. For example, a commercial driver's license is required for operators of vehicles having a GVWR in excess of 10,000 pounds. As a further example, regulations proscribe the number of hours a driver of a truck over 10,000 pounds may be operating the truck.

Therefore, there is an advantage for a shipper of cargo to use smaller, lighter trucks thereby eliminating many of these limiting regulations. Smaller, lighter trucks cost less to operate because drivers are not limited in how many hours they may be driving and drivers are not be required to have the training required to obtain a CDL. Further, smaller, lighter trucks are more fuel efficient resulting in cost savings.

However, there is a significant disadvantage to using smaller, lighter trucks. Box trucks, or other trucks such as flat-beds, are commonly used for cargo transport and typically have a cargo-carrying unit that rests on a truck frame and is completely separate from the truck's cab (i.e. driving compartment). These smaller trucks typically do not have a cargo-carrying unit that easily accommodates standard warehouse dock heights. Throughout the United States, warehouse dock heights, which have a cargo loading area of between 48″ to 52″ off the ground, are typically built to allow easy loading and unloading from larger trucks. Thus, the truck can be backed into a cargo loading area, the cargo-carrying unit can be opened to allow for loading or unloading, and cargo can be easily wheeled or moved between the loading dock and the truck. If smaller trucks had a cargo-carrying unit that matched the height of the loading docks, the truck's center of gravity would be far too high and operation of the truck, particularly in the loaded condition, would be unsafe. This is a significant impediment to the use of such smaller trucks in commercial cargo transport.

### SUMMARY OF THE INVENTION

The problem(s) with trucks used for transporting goods and materials being (a) overly restricted by any one of (i) governmental regulations, (ii) commercial requirements, or (iii) both; (b) incompatible with any one of (i) industrial environments, (ii) commercial environments, (iii) residential environments, or (iv) any combination thereof; (c) incapable of any one of (i) delivering heavy, (ii) delicate cargos, or (iii) both; (d) unsafe because of too high centers of gravity; or (e) any combination thereof are solved by a motor vehicle that, when loaded with cargo, would have a GVWR of about 10,000 pounds or below but to still be able to adjust the height of the cargo-carrying unit to accommodate various loading heights, including for example, standard warehouse docks (e.g., between about 48″ to about 52″ off the ground), so that use of such motor vehicle can be expanded. It is also desirable to be able to load cargo onto and unload cargo from the cargo-carrying unit in any one of (i) industrial environments, (ii) commercial environments, (iii) residential environments, or (iv) any combination thereof by allowing various positions for the cargo-carrying unit and/or structures associated with the cargo-carrying unit.

Aspects of embodiments and embodiments of the present invention meet these and other needs by providing, without limitation, a vehicle-mountable cargo transport apparatus configured for association with a motor vehicle so that the motor vehicle has a gross vehicle weight rating (GVWR) up to about 10,000 lbs and may be capable of transporting a cargo up to about 3,500 lbs or more and/or a motor vehicle including a vehicle-mountable cargo transport apparatus. The motor vehicle includes a chassis cab or cutaway chassis and the vehicle-mountable cargo transport apparatus. The vehicle-mountable cargo transport apparatus includes a cargo-carrying unit and an extensible spacer mechanism. The extensible spacer mechanism is configured for reversibly increasing a distance of the cargo-carrying unit with respect to the ground so as to accommodate at least one of receiving and delivering a cargo at a conventional loading dock. The cargo-carrying unit is configured for at least one of receiving and delivering a cargo at a conventional loading dock. Optionally, the cargo-carrying unit is configured for at least the other of receiving and delivering the cargo substantially at a street level and/or securing the cargo to maintain the cargo's integrity for delivery.

Accordingly, some aspects of embodiments and embodiments of the present invention provide an article comprising a motor vehicle configured for transporting a cargo up to about 3,500 lbs or more and having a gross vehicle weight rating (GVWR) up to about 10,000 lbs. The motor vehicle includes a chassis cab or cutaway chassis, a cargo-carrying unit, and an extensible spacer mechanism. The cargo-carrying unit is configured for at least one of receiving and delivering a cargo at a conventional loading dock, at least the other of receiving and delivering the cargo at street level. Optionally, the cargo-carrying unit is configured for securing cargo to maintain the cargo's integrity for delivery. The extensible spacer mechanism is configured for reversibly increasing a distance of the cargo-carrying unit with respect to the ground so as to accommodate the at least one of receiving and delivering of the cargo at a conventional loading dock.

Some other aspects of embodiments and embodiments of the present invention provide an article comprising a vehicle-mountable cargo transport apparatus configured for association with a motor vehicle so that the motor vehicle has a gross vehicle weight rating (GVWR) up to about 10,000 lbs and may be capable of transporting a cargo up to about 3,500 lbs or more. The vehicle-mountable cargo transport apparatus includes a cargo-carrying unit and is at least configured for one of receiving and delivering a cargo at a conventional loading dock. Optionally, the vehicle-mountable cargo transport apparatus also is at least configured for at least the other of receiving and delivering the cargo at street level. The cargo-carrying unit is configured for securing a cargo to maintain the cargo's integrity for delivery. The extensible spacer mechanism is configured for reversibly increasing a distance of the cargo-carrying unit with respect to the ground so as to accommodate the at least one of receiving and delivering the cargo at a conventional loading dock.

Still other aspects of embodiments and embodiments of the present invention provide a method of using a vehicle-mounted cargo transport apparatus associated with a motor vehicle so that the motor vehicle has a gross vehicle weight rating (GVWR) up to about 10,000 lbs and may be capable of transporting a cargo up to about 3,500 lbs or more. The method includes reversibly elevating a cargo-carrying unit and, optionally, may involve transitioning a lift gate. The reversible elevating of the cargo-carrying unit may involve activating an extensible spacer mechanism to reversibly elevate a cargo-carrying unit. The transitioning of a lift gate may involve transitioning a lift gate associated with the cargo-carrying unit from a closed position to one or both of (α) a first open position and (β) a second open position, and vice versa. In the closed position, the lift gate may be substantially vertically disposed, for example, as a removable end wall for the cargo-carrying unit. In the first open position, the lift gate may be substantially horizontally disposed such that the lift gate is about level with a floor of the cargo-carrying unit. In a second open position, the lift gate may be substantially horizontally disposed such that the lift gate is substantially parallel to the floor of the cargo-carrying unit in a plane lower than the floor of the cargo-carrying unit.

The present invention meets these and other needs by providing the following further aspects that may be associated or included with one or more of the above aspect of embodiments and embodiments of the present invention. For example, aspects of embodiments and embodiments relating to a motor vehicle and/or a vehicle-mountable cargo transport apparatus further may include a lift gate configured for transitioning from a closed position to one or both of (α) a first open position and (β) a second open position, and vice versa. The closed position, first open position, and second open position are as described in the immediately preceding paragraph above. According to some aspects, one or more pistons including any one of: (i) one or more hydraulic pistons, (ii) one or more pneumatic pistons, or (iii) combinations thereof, facilitate the transitioning of the lift gate from the closed position to one or both of (α) a first open position and (β) a second open position, and vice versa.

As another example, aspects of embodiments and embodiments relating to a motor vehicle and/or a vehicle-mountable cargo transport apparatus and/or a method, the extensible spacer mechanism may be a scissor lift that may include any one of (i) one or more linkages, (ii) one or more screws, (iii) one or more hydraulic pistons, (iv) one or more pneumatic pistons, or (v) combinations thereof to facilitate reversibly increasing the distance of the cargo-carrying unit with respect to the ground. In this manner, the motor vehicle and/or the vehicle-mountable cargo transport apparatus and/or the method are configurable or configured for accommodating the at least one of receiving and delivering of a cargo at a conventional loading dock.

As yet another example, aspects of embodiments and embodiments relating to a motor vehicle and/or a vehicle-mountable cargo transport apparatus and/or a method, the extensible spacer mechanism further may include a controller configured for at least operating the extensible spacer mechanism in fluid communication with one or more of the following hydraulic pumps (i) an electrically driven pump, (ii) a power take off (PTO) driven pump, (iii) clutch actuated pump, or (iv) combinations thereof. In further aspects, such a controller further may include one or more safety interlocks in communication with the controller. Such one or more safety interlocks may be configured for preventing the operation of at least the extensible spacer mechanism under one or more of the following conditions (i) the movement of the motor vehicle; (ii) a non-extension of at least one support leg configured for stabilizing any one of the motor vehicle, vehicle-mountable cargo transport apparatus, the cargo-carrying unit, or combinations thereof during an operation of the extensible spacer mechanism; or (iii) combinations thereof.

As still yet another example, aspects of embodiments and embodiments relating to a motor vehicle and/or a vehicle-mountable cargo transport apparatus and/or a method further may include any one of (i) at least one support leg configured for stabilizing any one of the motor vehicle, vehicle-mountable cargo transport apparatus, the cargo-carrying unit, or both during an operation of the extensible spacer mechanism; (ii) a locking mechanism configured for releasably locking the cargo-carrying unit to the motor vehicle; (iii) one or more spacers attached to any one of the cargo-carrying unit, the motor vehicle, or both to accommodate the cargo-carrying unit lifting mechanism; or (iv) combinations thereof.

Numerous other aspects of embodiments, embodiments, features, and advantages of the present invention will appear from the following detailed description and the accompanying drawings. In the description and/or the accompanying drawings, reference is made to exemplary aspects of embodiments and/or embodiments of the invention which can be applied individually or combined in any way with each other. Such aspects of embodiments and/or embodiments do not represent the full scope of the invention. Reference should therefore be made to the claims herein for interpreting the full scope of the invention. In the interest of brevity and conciseness, any ranges of values set forth in this specification contemplate all values within the range and are to be construed as support for claims reciting any sub-ranges having endpoints which are real number values within the specified range in question. By way of a hypothetical illustrative example, a disclosure in this specification of a range of from 1 to 5 shall be considered to support claims to any of the following ranges: 1-5; 1-4; 1-3; 1-2; 2-5; 2-4; 2-3; 3-5; 3-4; and 4-5. Also in the interest of brevity and conciseness, it is to be understood that such terms as “is,” “are,” “includes,” “having,” “comprises,” and the like are words of convenience and are not to be construed as limiting terms and yet may encompass the terms “comprises,” “consists essentially of,” “consists of,” and the like as is appropriate.

These and other aspects, advantages, and salient features of the present invention will become apparent from the following detailed description, the accompanying drawings, and the appended claims.

### BRIEF DESCRIPTION OF THE FIGURES

The drawings referenced herein form a part of the specification. Features shown in the drawings are meant to be illustrative of some, but not all, embodiments of the invention, unless otherwise explicitly indicated, and implications to the contrary are otherwise not to be made. Although like reference numerals correspond to similar, though not necessarily identical, components and/or features in the drawings, for the sake of brevity, reference numerals or features having a previously described function may not necessarily be described in connection with other drawings in which such components and/or features appear.

FIG. 1 is a perspective view of a motor vehicle configured for cargo transport including a vehicle-mountable cargo transport apparatus showing a cargo-carrying unit in a non-elevated position and a lift gate in an open position according to aspects of embodiments of the present invention;

FIG. 2 is a side view of a motor vehicle configured for cargo transport including a vehicle-mountable cargo transport apparatus showing a cargo-carrying unit in a non-elevated position and a lift gate in a closed position according to aspects of embodiments of the present invention.

FIG. 3 is a rear view of a vehicle-mountable cargo transport apparatus showing a lift gate in a closed position according to aspects of embodiments of the present invention;

FIG. 4 is a side view of a motor vehicle configured for cargo transport including a vehicle-mountable cargo transport apparatus showing a cargo-carrying unit in a non-elevated position and a lift gate in an open position according to aspects of embodiments of the present invention;

FIG. 5 is a side view of a motor vehicle configured for cargo transport including a vehicle-mountable cargo transport apparatus showing a cargo-carrying unit in a non-elevated position and a lift gate in an open and lowered position according to aspects of embodiments of the present invention;

FIG. 6 is a side view of a motor vehicle configured for cargo transport including a vehicle-mountable cargo transport apparatus showing a cargo-carrying unit in an elevated position and a lift gate closed position according to aspects of embodiments of the present invention;

FIG. 7 is a side view of a motor vehicle configured for cargo transport including a vehicle-mountable cargo transport apparatus showing a cargo-carrying unit in an elevated position and a lift gate in an open position according to aspects of embodiments of the present invention;

FIG. 8 is a perspective view of a motor vehicle configured for cargo transport including a vehicle-mountable cargo transport apparatus showing a chassis cab according to aspects of embodiments of the present invention; and

FIG. 9 is a bottom view of a vehicle-mountable cargo transport apparatus according to aspects of embodiments of the present invention.

### DETAILED DESCRIPTION OF THE INVENTION

In the following detailed description of exemplary aspects of embodiments and embodiments of the invention, reference is made to the accompanying drawings that form a part hereof, and in which are shown by way of illustration specific aspects of embodiments and embodiments in which the invention may be practiced. While these aspects of embodiments and embodiments are described in sufficient detail to enable those skilled in the art to practice the invention, it will nevertheless be understood that no limitation of the scope of the present disclosure is thereby intended. Alterations and further modifications of the features illustrated herein, and additional applications of the principles illustrated herein, which would occur to one skilled in the relevant art and having possession of this disclosure, are to be considered within the scope of this disclosure. Specifically, other aspects of embodiments and embodiments may be utilized, and logical, mechanical, electrical, electro-optical, and other changes may be made without departing from the spirit or scope of the present invention. Accordingly, the following detailed description is not to be taken in a limiting sense, and the scope of the present invention is defined by the appended claims. It is also understood that terms such as “top,” “bottom,” “outward,” “inward,” and the like are words of convenience and are not to be construed as limiting terms.

The present invention is directed to a motor vehicle configured for cargo transport, such as a box truck, a vehicle-mountable cargo transport apparatus 8 including a cargo-carrying unit for use in connection with a motor vehicle, such as a chassis cab or cutaway chassis. The vehicle-mountable cargo transport apparatus 8 enables adjustment of the height of a cargo-carrying unit with respect to the chassis cab or cutaway chassis (and, thus the ground) and adjustment of the position of the cargo-carrying unit door to facilitate the loading and unloading of cargo. As shown in the Figures and explained in more detail below, the motor vehicle configured for cargo transport 100 generally comprises a vehicle such as a truck 10 having a chassis cab 12 or cutaway chassis 12′ (not shown; however, known to those skilled in the art) and a vehicle-mountable cargo transport apparatus 8. Such apparatus 8 includes a cargo-carrying unit 14 and an extensible spacer mechanism 28 such as, for example, a scissor lift. The extensible spacer mechanism 28 such as, for example, a scissor lift, may be attachable to or integrally formed with the chassis cab 12 or cutaway chassis 12′.

Examples of suitable trucks 10 that may be a suitable chassis cab 12 or cutaway chassis 12′ (e.g., the frame, wheels, and machinery of a motor vehicle, on which the vehicle-mountable cargo transport apparatus 8 may be supported) may include those listed in Table 1 and Table 2 below.

TABLE 1
Examples of Vehicles with GVWR between 8,500 and 10,000 lbs.
This list is provided as an example and does not represent all vehicles
that may have configurations of 10,000 lbs and below. GVWR and
configurations that are over 10,000 lbs are not aspects of embodiments
nor embodiments of the present invention even if the model is listed below

| Model | | | |
|---|---|---|---|
| Year | Manufacturer | Make | Model |
| 2009 | Chrysler LLC | DODGE ® | RAM ® 2500 Pickup 2WD |
| 2009 | Cummins | DODGE ® | RAM ® Diesel 2500 |
| | | | Pickup 4WD |
| 2009 | Ford Motor | FORD ® | E350 Van |
| | Company | | |
| 2009 | Ford Motor | FORD ® | E350 Van |
| | Company | | |
| 2009 | Ford Motor | LINCOLN ® | NAVIGATOR ® 4WD |
| | Company | | FFV |
| 2009 | General Motors | CHEVROLET ® | G3500 Van 2WD Cargo |
| 2009 | General Motors | CHEVROLET ® | K25 SILVERADO ® 4WD |
| 2009 | General Motors | CHEVROLET ® | K35 SILVERADO ® 4WD |
| 2009 | General Motors | GMC ® | K2500 YUKON ® XL |
| | | | 4WD |
| 2009 | General Motors | HUMMER ® | H2 SUV 4WD |
| 2008 | Chrysler LLC | DODGE ® | RAM ® 2500 Cab Chas |
| | | | 2WD |
| 2008 | Cummins | DODGE ® | RAM ® 2500 Pickup 4WD |
| 2008 | Ford Motor | FORD ® | E250 Van |
| | Company | | |
| 2008 | Ford Motor | FORD ® | E250 Van FFV |
| | Company | | |
| 2008 | Ford Motor | FORD ® | E350 Van |
| | Company | | |
| 2008 | Ford Motor | FORD ® | E350 Van |
| | Company | | |
| 2008 | Ford Motor | FORD ® | F350 4WD |
| | Company | | |
| 2008 | General Motors | CHEVROLET ® | G3500 Van 2WD |
| 2008 | General Motors | CHEVROLET ® | K25 SILVERADO ® 4WD |
| 2008 | General Motors | GMC ® | K2500 YUKON ® XL |
| | | | 4WD |
| 2008 | General Motors | HUMMER ® | H2 SUV 4WD |
| 2008 | Mercedes-Benz | MERCEDES- | DODGE ® 2500 |
| | | BENZ ® | |
| 2007 | Chrysler LLC | DODGE ® | RAM ® 2500 Pickup 2WD |
| 2007 | Cummins | DODGE ® | RAM ® 2500 Pickup 4WD |
| 2007 | Ford Motor | FORD ® | E250 ECONOLINE ® |
| | Company | | 2WD |
| 2007 | Ford Motor | FORD ® | E350 2WD |
| | Company | | |
| 2007 | Ford Motor | FORD ® | E350 2WD |
| | Company | | |
| 2007 | Ford Motor | FORD ® | F350 4WD |
| | Company | | |
| 2007 | General Motors | CHEVROLET ® | K2500 SUBURBAN ® |
| | | | 4WD |
| 2007 | General Motors | CHEVROLET ® | K2500 HD |
| | | | SILVERADO ® Classic |
| | | | 4WD |
| 2007 | General Motors | CHEVROLET ® | K3500 SILVERADO ® |
| | | | Classic 4WD |
| 2007 | General Motors | HUMMER ® | H2 SUV 4WD |
| 2007 | Mercedes-Benz | Mercedes-Benz | DODGE ® 2500 |
| 2006 | Ford Motor | FORD ® | E250 ECONOLINE ® |
| | Company | | 2WD |
| 2006 | Ford Motor | FORD ® | E350 2WD |
| | Company | | |
| 2006 | Ford Motor | FORD ® | E350 2WD |
| | Company | | |
| 2006 | Ford Motor | FORD ® | E350 2WD |
| | Company | | |
| 2006 | General Motors | CHEVROLET ® | C2500 AVALANCHE ® |
| | | | 2WD |

TABLE 2
Examples of 2010 Model Full-Size Vans and 2010 Model Light Trucks with GVWR of 10,000 lbs
and below. This list is provided as an example and does not represent all vehicles that may have
configurations of 10,000 lbs and below. GVWR and configurations that are over 10,000 lbs are not
aspects of embodiments nor embodiments of the present invention even if the model is listed below

| | | | | | | MPG |
|---|---|---|---|---|---|---|
| | Available | Drive | Base | Optional | Diesel | Estimate |
| Make/Model | Body Style(s) | Train | Engine | Engine(s) | Engine | (City/Hwy.) |
| CHEVROLET ® | Cargo | N/A | 4.8 L V-8 | 6.0 L V-8 | 6.6 L V-8 | 13/18 |
| Express | | | | | | |
| Commercial | | | | | | |
| Cutaway | | | | | | |
| DODGE ® | SWB/LWB/ | N/A | (diesel) | — | 3.0 L V-6 | N/A |
| SPRINTER ® | LWB EXT | | | | | |
| Cab Chassis | | | | | | |
| FORD ® | Cargo | N/A | 4.6 L V-8 | 5.4 L V-8 | — | N/A |
| ECONOLINE ® | | | | | | |
| E 150 | | | | | | |
| FORD ® | Cargo/ | N/A | 4.6 L V-8 | 5.4 L V-8 | — | N/A |
| ECONOLINE ® | Cargo-Super | | | | | |
| E 250/250 HD | | | | | | |
| FORD ® | Cargo/ | N/A | 5.4 L V-8 | 6.8 L V-10 | 6.0 L V-8T | N/A |
| ECONOLINE ® | Cargo-Super | | | | | |
| E 350 | | | | | | |
| FORD ® | SWB-SRW/ | N/A | 5.4 L V-8 | 6.8 L V-10 | 6.0 L V-8T | N/A |
| ECONOLINE ® | SWB-DRW/ | | | | | |
| E 350/E450 | LWB-DRW | | | | | |
| Comm. | | | | | | |
| Cutaway | | | | | | |
| FORD ® | SWB-SRW/ | N/A | 5.4 L V-8 | 6.8 L V-10 | 6.0 L V-8T | N/A |
| ECONOLINE ® | SWB-DRW- | | | | | |
| E 250/350/ | LWB- | | | | | |
| 450 Comm. | SRW/LWB- | | | | | |
| Strip. Chas. | DRW | | | | | |
| GMC ® | Cargo | N/A | 5.3 L V-8 | 6.0 L V-8 | 6.5 L V-8 | N/A |
| SAVANA ® | | | | | | |
| Special | | | | | | |
| Cutaway | | | | | | |
| CHEVROLET ® | Regular Cab/ | 2WD/ | 2.8 L | 3.7 L | — | 18/25-14/ |
| COLORADO ® | Ext. Cab/ | 4WD | DOHC | DOHC I-5/ | | 19 |
| | Crew Cab | | I-4 | 5.3 L OHV | | |
| | | | | V-8 | | |
| CHEVROLET ® | Regular Cab/ | 2WD/ | 4.3 L V- | 4.8 L V-8/ | — | 15/20-14/ |
| SILVERADO ® | Ext. Cab/ | 4WD | 6/4.8 L | 5.3 L V-8/ | | 18 |
| 1500 | Crew Cab- | | V-8 | 6.0 L V-8 | | |
| | Short/Reg./ | | | | | |
| | Long Box | | | | | |
| CHEVROLET ® | Crew Cab- | 2WD/ | 6.0 L V- | — | — | 20/20 |
| SILVERADO ® | Short Bed | 4WD | 8 + dual | | | |
| Hybrid | | | electric | | | |
| CHEVROLET ® | Regular Cab/ | 2WD/ | 6.0 L V-8 | — | 6.6 L V-8 | N/A |
| SILVERADO ® | Ext. Cab/ | 4WD | | | | |
| 2500 HD | Crew Cab- | | | | | |
| | Long Box- | | | | | |
| | DRW | | | | | |
| CHEVROLET ® | Chassis Cab/ | 2WD/ | 6.0 L V-8 | — | 6.6 L V-8 | N/A |
| SILVERADO ® | Crew Cab- | 4WD | | | | |
| 3500 HD | SRW/DRW- | | | | | |
| | LWB- | | | | | |
| | Straight Frame | | | | | |
| DODGE ® | Regular Cab/ | 2WD/ | 3.7 L V-6 | 4.7 L V-8 | — | 16/22-15/ |
| DAKOTA ® | Quad Cab- | 4WD | | | | 21 |
| | SWB/LWB | | | | | |
| DODGE ® | Regular Cab/ | 2WD/ | 3.7 L V-6 | 4.7 L V-8/ | — | 15/20-13/ |
| RAM ® 1500 | Quad Cab/ | 4WD | | 5.7 L V-8 | | 18 |
| | Crew Cab- | | | | | |
| | SWB/LWB | | | | | |
| DODGE ® | Regular Cab/ | 2WD/ | 5.7 L V-8 | — | 6.7 L I-6T | N/A |
| RAM ® 3500 | Quad Cab- | 4WD | | | | |
| | SWB/LWB- | | | | | |
| | DRW | | | | | |
| DODGE ® | Chassis Cab | 2WD/ | 5.7 L V-8 | — | 6.7 L I-6T | N/A |
| RAM ® 3500 | | 4WD | | | | |
| Chassis Cab | | | | | | |
| DODGE ® | Chassis Cab | 2WD/ | (diesel | — | 6.7 L I- | N/A |
| RAM ® 4500 | | 4WD | only) | | 6T | |
| Chassis Cab | | | | | | |
| FORD ® F-150 | Regular Cab/ | 2WD/ | 4.2 L V-6 | 4.6 L SOHC | — | 16/17-20/ |
| | Super Cab/ | 4WD | | V-8/5.4 L | | 22 |
| | SuperCrew- | | | SOHC V-8 | | |
| | SWB/LWB | | | | | |
| FORD ® F-250 | Regular Cab/ | 2WD/ | 5.4 L | 6.8 L SOHC | 6.4 L V-8T | N/A |
| Super Duty | Crew Cab/ | 4WD | SOHC | V-10 | | |
| | Super Cab- | | V-8 | | | |
| | SWB/LWB | | | | | |
| FORD ® F-350 | Regular Cab/ | 2WD/ | 5.4 L | 6.8 L SOHC | 6.4 L V-8T | N/A |
| Super Duty | Crew Cab/ | 4WD | SOHC | V-10 | | |
| | Super Cab/ | | V-8 | | | |
| | Chassis Cab- | | | | | |
| | SRW/DRW | | | | | |
| FORD ® F-350/ | Chassis Cab- | 2WD/ | 5.4 L | 6.8 L SOHC | 6.4 L V-8T | N/A |
| 450/550 | SRW/DRW- | 4WD | SOHC | V-10 | | |
| Chassis Cab | LWB | | V-8 | | | |
| FORD ® | Regular Cab/ | 2WD/ | 2.3 L I-4 | 4.0 L V-6 | — | N/A |
| RANGER ® | Super Cab- | 4WD | | | | |
| | SWB/LWB | | | | | |
| GMC ® | Crew Cab | 2WD/ | 6.0 L V- | — | — | 21/22-20/ |
| SIERRA ® | | 4WD | 8 + | | | 20 |
| Hybrid | | | Dual | | | |
| | | | electric | | | |
| GMC ® | Crew Cab | AWD | 6.0 L V-8 | — | — | 12/19 |
| SIERRA ® | | | | | | |
| Denali | | | | | | |
| GMC ® | Regular Cab/ | 2WD/ | 6.0 L V-8 | — | 6.6 L V-8 | N/A |
| SIERRA ® | Ext. Cab/ | 4WD | | | | |
| 2500 HD | Chassis Cab | | | | | |
| GMC ® | Chassis Cab/ | 2WD/ | 6.0 L V-8 | — | 6.6 L V-8 | N/A |
| SIERRA ® | Crew Cab- | 4WD | | | | |
| 3500 HD | SRW/DRW- | | | | | |
| | LWB- | | | | | |
| | Straight Frame | | | | | |
| HONDA ® | Crew Cab | AWD | 3.5 L | — | — | 15/20 |
| RIDGELINE ® | | | SOHC | | | |
| | | | V-6 | | | |
| MAZDA ® B- | Regular Cab/ | 2WD/ | 2.3 L I-4 | 4.0 L V-6 | — | 21/26-14/ |
| SERIES | Cab Plus | 4WD | | | | 18 |
| MITSUBISHI ® | Extended Cab/ | 2WD/ | 3.7 L | — | — | 15/19-16/ |
| RAIDER ® | Double Cab | 4WD | SOHC | | | 22 |
| | | | V-6 | | | |
| NISSAN ® | King Cab/ | 2WD/ | 5.6 L | — | — | 12/17 |
| TITAN ® | Crew Cab | 4WD | DOHC | | | |
| | | | V-8 | | | |
| SUZUKI ® | Extended Cab/ | 2WD/ | 2.5 L | 4.0 L | — | 19/23-15/ |
| EQUATOR ® | Crew Cab | 4WD | DOHC | DOHC V-6 | | 20 |
| | | | I-4 | | | |
| TOYOTA ® | Regular Cab/ | 2WD/ | 2.7 L | 4.0 L | — | 15/18-20/ |
| TACOMA ® | Access Cab/ | 4WD | DOHC | DOHC V-6 | | 25 |
| | Double Cab | | I-4 | | | |
| TOYOTA ® | Regular Cab/ | 2WD/ | 4.0 L | 4.7 L | — | 15/19-13/ |
| TUNDRA ® | Access Cab/ | 4WD | DOHC | DOHC V-8/ | | 16 |
| | Double Cab | | V-6 | 5.7 L | | |
| | | | | DOHC V-8 | | |

| | | Curb | GVW | | |
|---|---|---|---|---|---|
| | Passenger | Weight | Range | Payload | Wheelbase |
| Make/Model | Capacity | (lbs) | (lbs.) | (lbs.) | (in.) |
| CHEVROLET ® | 2 | N/A | 9,500-12,000 | 5,051-7,315 | 139/177 |
| Express | | | | | |
| Commercial | | | | | |
| Cutaway | | | | | |
| DODGE ® | 2 | N/A | 8,550-11,030 | 6,460-6,543 | 144/170 |
| SPRINTER ® | | | | | |
| Cab Chassis | | | | | |
| FORD ® | 2-5 | N/A | 6,050 | 1,390 | 138 |
| ECONOLINE ® | | | | | |
| E 150 | | | | | |
| FORD ® | 2-5 | N/A | 7,200-8,550 | 2,125-3,470 | 138 |
| ECONOLINE ® | | | | | |
| E 250/250 HD | | | | | |
| FORD ® | 2 | N/A | 9,400-9,500 | 3,915-4,160 | 138 |
| ECONOLINE ® | | | | | |
| E 350 | | | | | |
| FORD ® | 2 | N/A | 9,600-14,500 | 4,945-5,825 | 138-158 |
| ECONOLINE ® | | | | | |
| E 350/E450 | | | | | |
| Comm. | | | | | |
| Cutaway | | | | | |
| FORD ® | 2 | N/A | 9,400-14,500 | 5,360-5,800 | 138-176 |
| ECONOLINE ® | | | | | |
| E 250/350/ | | | | | |
| 450 Comm. | | | | | |
| Strip. Chas. | | | | | |
| GMC ® | 2 | N/A | 9,500-12,000 | 5,051-7,315 | 139/177 |
| SAVANA ® | | | | | |
| Special | | | | | |
| Cutaway | | | | | |
| CHEVROLET ® | 2-5 | 3,366-4,218 | 4,850-5,300 | 1,168-1,422 | 111.3-126 |
| COLORADO ® | | | | | |
| CHEVROLET ® | 3-6 | 4,448-5,371 | 6,400-7,000 | 1,952-1,625 | 119.0-157.5 |
| SILVERADO ® | | | | | |
| 1500 | | | | | |
| CHEVROLET ® | 3-6 | 5,641-5,882 | 7,100-7,300 | 1,418-1,459 | 143.5 |
| SILVERADO ® | | | | | |
| Hybrid | | | | | |
| CHEVROLET ® | 3-6 | 5,308-6,906 | 9,200 | 2,294-3,636 | 133-167 |
| SILVERADO ® | | | | | |
| 2500 HD | | | | | |
| CHEVROLET ® | 3-6 | 5,653-7,225 | 9,500-11,400 | 3,464-5,307 | 133-167 |
| SILVERADO ® | | | | | |
| 3500 HD | | | | | |
| DODGE ® | 3-6 | 4,251-4,859 | 6,010 | 1,150-1,720 | 131.3 |
| DAKOTA ® | | | | | |
| DODGE ® | 3-6 | N/A | 6,025-6,800 | 1,290-1,850 | 120.5-140.5 |
| RAM ® 1500 | | | | | |
| DODGE ® | 3-6 | 5,919-7,557 | 10,200-12,500 | N/A | 140.5-160.5 |
| RAM ® 3500 | | | | | |
| DODGE ® | 3-6 | N/A | 10,200-12,500 | N/A | 143.5-167.5 |
| RAM ® 3500 | | | | | |
| Chassis Cab | | | | | |
| DODGE ® | 3-6 | N/A | 16,500 | N/A | 144.5-192.5 |
| RAM ® 4500 | | | | | |
| Chassis Cab | | | | | |
| FORD ® F-150 | 3-6 | 4,615-5,849 | 6,500-8,200 | 1.830-3,020 | 126-163 |
| FORD ® F-250 | 3-6 | 5,675-6,685 | 9,400-10.000 | 2,860-3,170 | 137-172.4 |
| Super Duty | | | | | |
| FORD ® F-350 | 3-6 | 5,813-7,270 | 10,700-13,000 | 4,220-5,720 | 137-172.4 |
| Super Duty | | | | | |
| FORD ® F-350/ | 3-6 | N/A | 10,000-19,000 | 4,820-11,550 | 141-201 |
| 450/550 | | | | | |
| Chassis Cab | | | | | |
| FORD ® | 3-5 | 3,030-3,668 | 4,380-5,000 | 1,260 | 111.5-125.9 |
| RANGER ® | | | | | |
| GMC ® | 6 | 5,641-5,882 | 7,100-7,300 | 1,418-1,459 | 143.5 |
| SIERRA ® | | | | | |
| Hybrid | | | | | |
| GMC ® | 6 | 5,181-5,408 | 6,800-7,000 | 1,592-1,619 | 143.5 |
| SIERRA ® | | | | | |
| Denali | | | | | |
| GMC ® | 3-6 | 4,837-5,771 | 9,200 | 3,986-4,534 | 133-167 |
| SIERRA ® | | | | | |
| 2500 HD | | | | | |
| GMC ® | 3-6 | 4,837-6,361 | 9,200-12,000 | 2,926-8,956 | 133-167 |
| SIERRA ® | | | | | |
| 3500 HD | | | | | |
| HONDA ® | 5 | 4,500-4,537 | 6,050 | 1,549-1,554 | 122 |
| RIDGELINE ® | | | | | |
| MAZDA ® B- | 3-5 | 2,929-3,662 | 4,280-5,120 | 1,200-1,260 | 111.6-125.9 |
| SERIES | | | | | |
| MITSUBISHI ® | 5 | 4,300-4,750 | 6010 | 1,200-1,700 | 131.3 |
| RAIDER ® | | | | | |
| NISSAN ® | 2-5 | 4,986-5,618 | 7,000-7,200 | 1,650-2,062 | 139.8-159.5 |
| TITAN ® | | | | | |
| SUZUKI ® | 3-5 | 3,685-4,518 | 4,690-5,730 | 883-1,471 | 125.9-139.9 |
| EQUATOR ® | | | | | |
| TOYOTA ® | 3-5 | 3,140-4,100 | 4,550-5,350 | 1,390-1,540 | 109.4-140.9 |
| TACOMA ® | | | | | |
| TOYOTA ® | 3-5 | 4,610-5,705 | 6,200-7,200 | 1,350-1,990 | 126.8/164.6 |
| TUNDRA ® | | | | | |

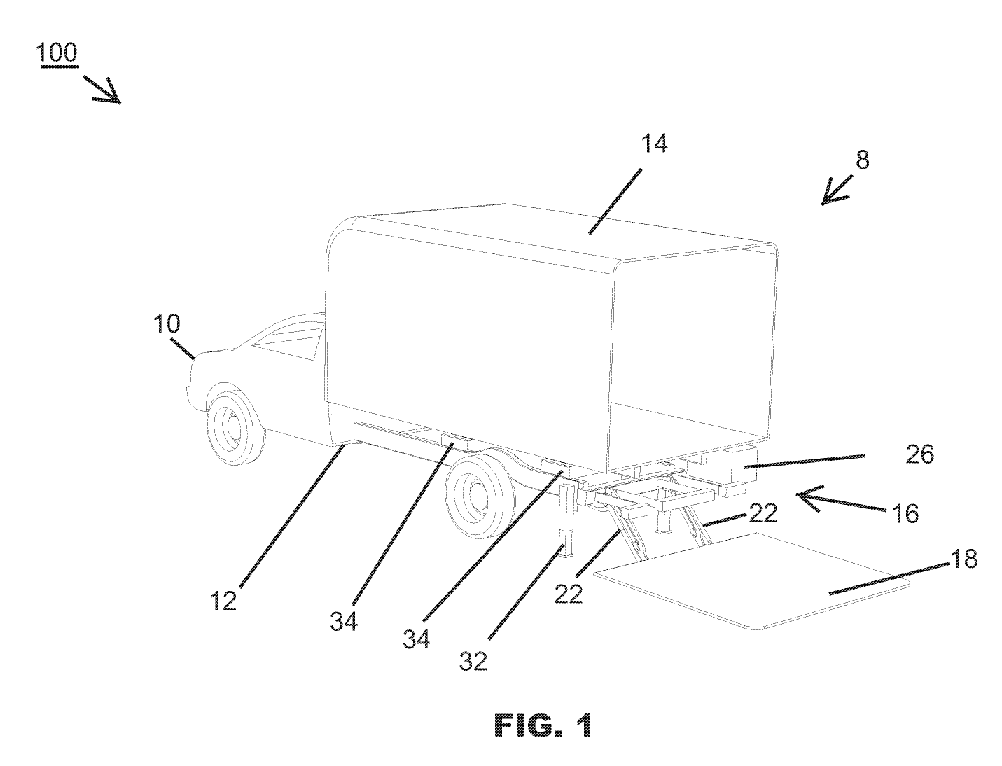

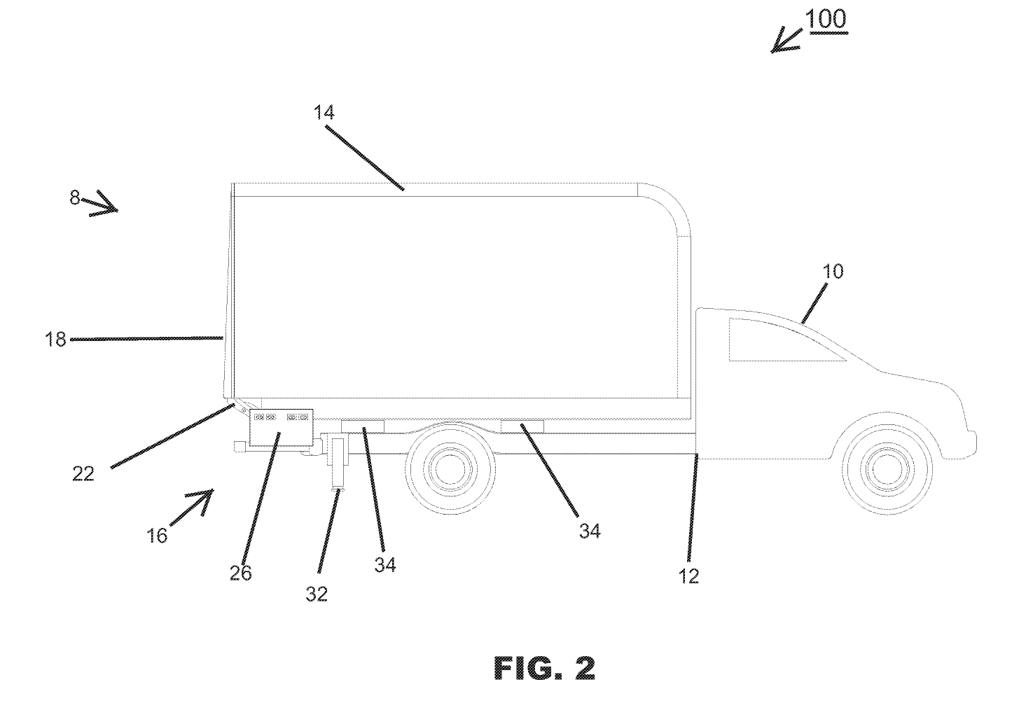

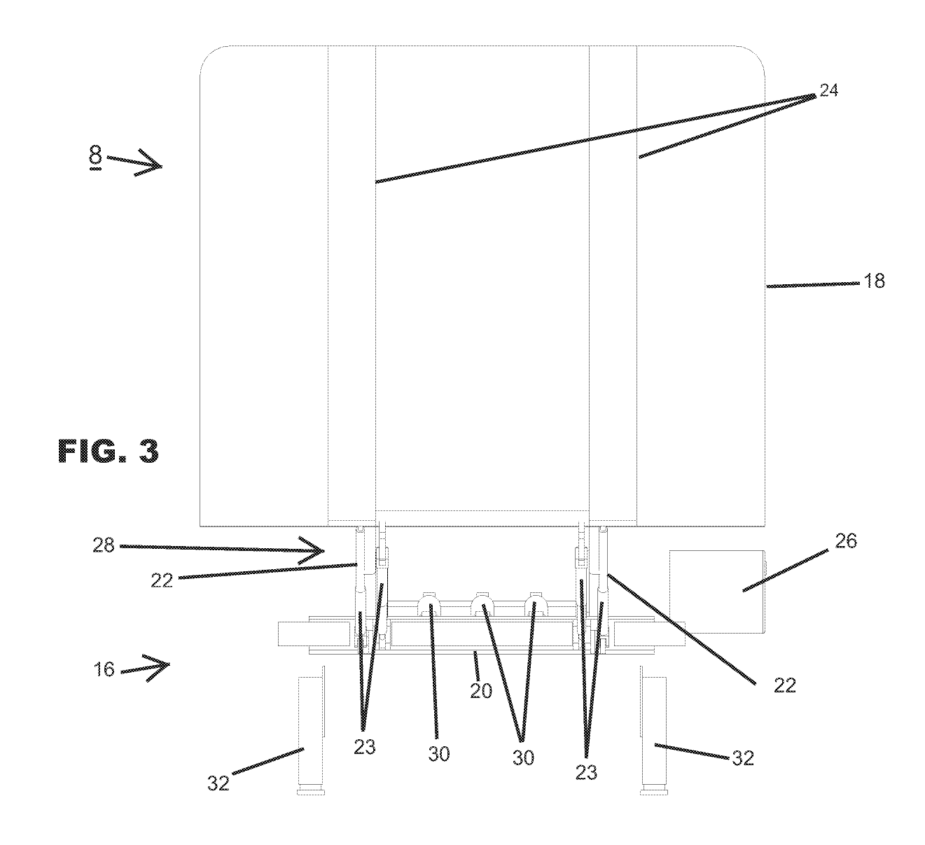

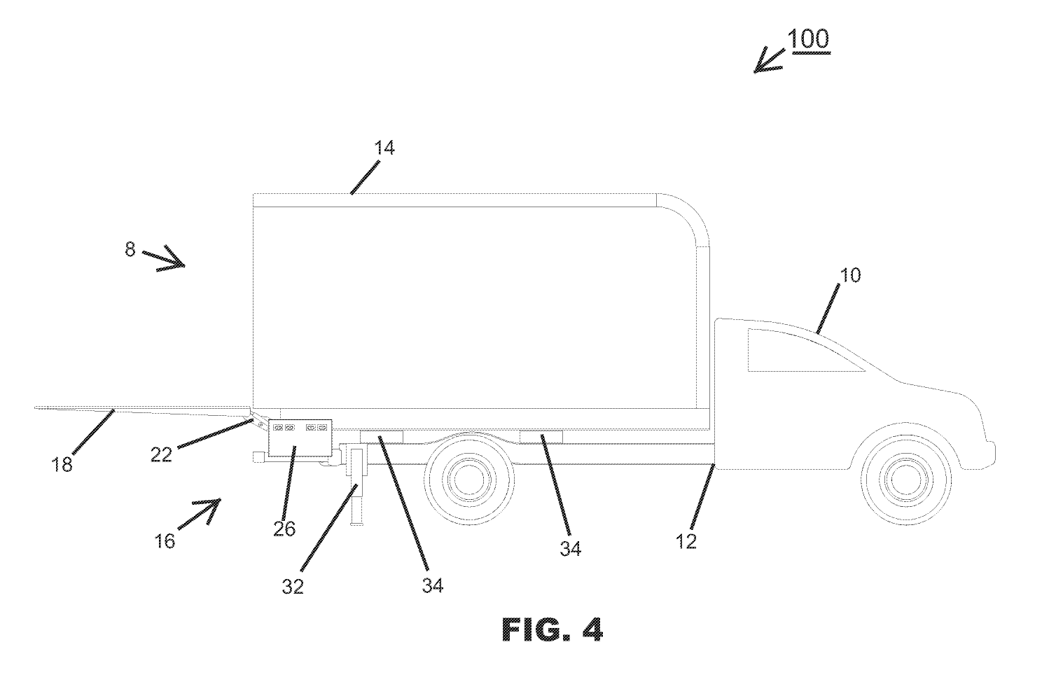

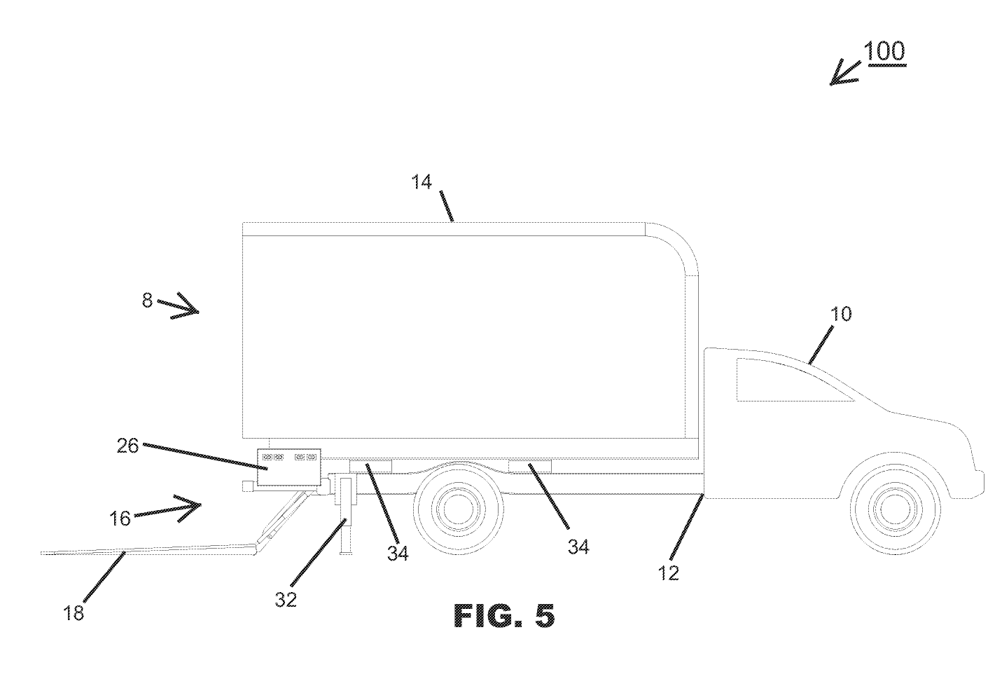

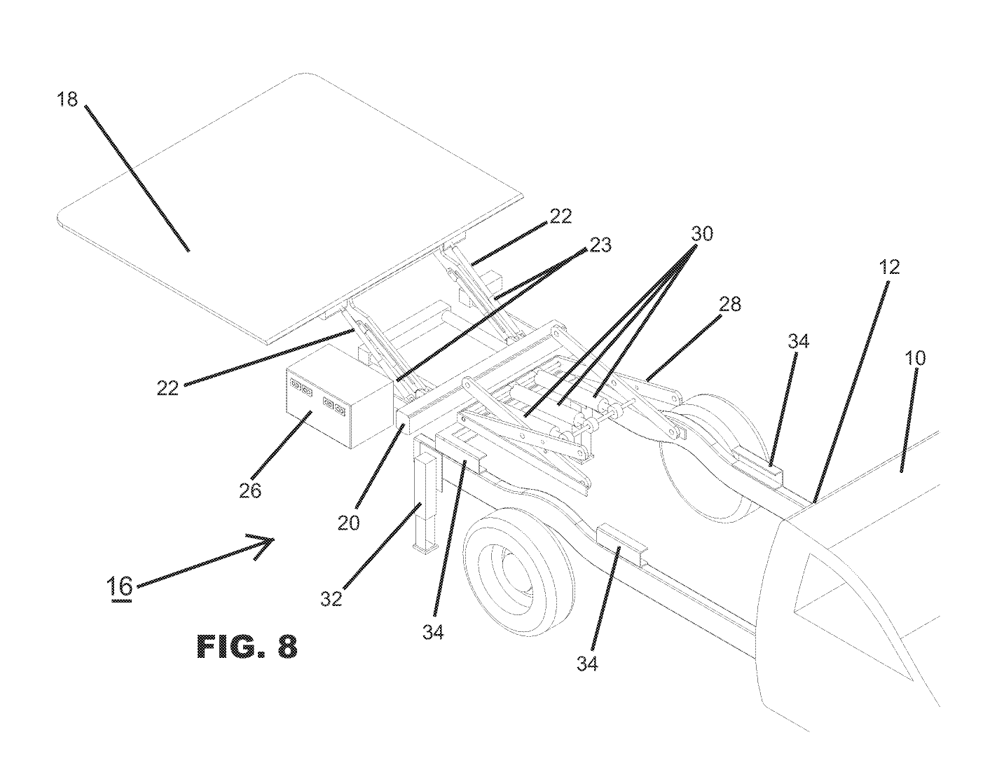

In aspects of embodiments and embodiments of the present invention, the cargo carrying unit 14 may be a body having a generally box-shape and having a top, a side, walls on each side, and a front end wall that is closest to the truck's cab. In these aspects of embodiments and embodiments, the rear end of the cargo carrying unit 14 may be open and a detachable rear access door, referred to herein as a lift gate 18, is provided on a lift frame 16 (a good portion of which is shown in FIG. 8) to close the cargo carrying unit 14, as shown in FIGS. 2 and 3. More specifically, the lift frame 16 (a good portion of which is shown in FIG. 8) is configured to gradually transition the lift gate 18 from a vertical cargo carrying unit 14 closure position (FIGS. 2-3), to a first open tailgate position (FIG. 4), and to a second open tailgate position (as shown in FIGS. 1 and 5) that is lower than the elevation of the cargo carrying unit 14. Examples of suitable lift gates 18 include, without limitation, the all-aluminum tailgate loader L750AL/TF available from Aluhebetechnik (AHT), Gattendorf, Austria, EU (see e.g., Products/Tailgate loaders at http://www.aht-mhw.com/en/content/index.htm) and the Level-Lieft/Cantilever Gate, Part # BZ-33 and BZ-44 from Waltco, Talmadge, Ohio, USA (see e.g., http://www.waltcoliftgates.com/assets/attachments/file/WLT-FLBroch2010.pdf)). Other examples of possible lift gates 18 may include, without limitation, DL 500/750/950 Lifter available from Dautel GmbH, Leingarten, Germany, EU (see e.g., http://dautel.de); DLB 1000-3000 47L Ladebordwand available from Dautel GmbH, Leingarten, Germany, EU (see e.g., http://dautel.de); DLB 1000-3000 47S Ladebordwand available from Dautel GmbH, Leingarten, Germany, EU (see e.g., http://dautel.de); 1000-3000 Unterfahrbare Ladebordwand available from Dautel GmbH, Leingarten, Germany, EU (see e.g., http://dautel.de); DLB 750-27X1, DLB 750-47, and DLB 950-47 Ladebordwand available from Dautel GmbH, Leingarten, Germany, EU (see e.g., http://dautel.de); 500 CITYFIX Ladehilfe available from Prinz und Co. KG, Kottingbrunn, Austria, EU (see e.g., http://www.prinz-ladebordwaende. at); 1000-1500 KFL Hubladebuehne available from Prinz und Co. KG, Kottingbrunn, Austria, EU (see e.g., http://www.prinz-ladebordwaende.at); 1000 UNIFOLD Hubladebuehne available from Prinz und Co. KG, Kottingbrunn, Austria, EU (see e.g., http://www.prinz-ladebordwaende.at); 500-3000 K Hubladebuehne available from Prinz und Co. KG, Kottingbrunn, Austria, EU (see e.g., http://www.prinz-ladebordwaende.at); 750-3000 KUZ Hubladebuehne available from Prinz und Co. KG, Kottingbrunn, Austria, EU (see e.g., http://www.prinz-ladebordwaende.at); RPT1507-RPT1507F folding platform available from Ratcliff Tail Lifts Ltd., Welwyn Garden City, England, EU (see e.g., http://palfinger.com); RQR518, RQR758, and RQR1008, Type 1 or 2 rear frame lift available from Ratcliff Tail Lifts Ltd., Welwyn Garden City, England, EU (see e.g., http://palfinger.com); RATK1007 folding platform available from Ratcliff Tail Lifts Ltd., Welwyn Garden City, England, EU (see e.g., http://palfinger.com); Minifix 500 folding platform available from Ratcliff Tail Lifts Ltd., Welwyn Garden City, England, EU (see e.g., http://palfinger.com); and Athlet quattro cantilever lifting available from Ratcliff Tail Lifts Ltd., Welwyn Garden City, England, EU (see e.g., http://palfinger.com). When the lift gate 18 is in a closed position, the truck 10 may be backed up to a loading dock as shown in FIGS. 2 and 3. Then the lift gate 18 may be transitioned to the first open tailgate position as shown in FIG. 4, for example, to facilitate loading cargo onto and unloading cargo from the cargo-carrying unit 14. When the lift gate 18 is in the second open tailgate position (as shown in FIGS. 1 and 5), cargo may be rolled from the ground surface onto the lift gate 18 such that when the lift gate 18 is raised to the first open tailgate position, such cargo may be easily transferred from the lift gate 18 to the cargo carrying unit 14, and vice versa. This feature is particularly usefully when heavy cargo is being loaded onto or unloaded from the cargo-carrying unit 14 and there is no raised loading dock available. A top of the lift gate 18 (which is also the side of the lift gate 18 that is enclosed when the lift gate 18 is in the closed position) may include a grated surface to provide a slip and skid resistance surface, particularly when heavy objects are being rolled in or from the cargo carrying unit 14.

Referring now to FIGS. 3, 8 and 9, the lift frame 16 (a good portion of which is shown in FIG. 8) may include a support bar 20 to which lift gate movement mechanisms 22 are pivotally attached. As shown in FIGS. 3 and 8, the lift gate movement mechanisms 22 may also be pivotally attached to lift gate arms 24 that support the lift gate 18 platform. The lift gate movement mechanisms 22 may utilize pneumatic or hydraulic pistons, such as pistons 23, for producing the force required for movement of the lift gate 18 between its various positions, as discussed above. Movement of the lift gate 18 may be activated by an operator invoking controls on a controller 26 that may be attached to one or both sides of the lift frame 16 (a good portion of which is shown in FIG. 8). An additional controller 27 (not shown) for activating the lift gate 18 may be provided on the cargo-carrying unit 14 itself. Examples of possible controller 27 may include, without limitation, hydraulic systems and associated control units available from Weber-Hydraulik GmbH, Losenstein, Austria, EU (see e.g., http://www.weber.de/hydraulik/en/html/kontakt-austria.php); hydraulic systems and associated control units available from Atlantic Industrial Technologies, Shirley, N.Y., USA (see e.g., http://www.aitzone.com/index.php); and hydraulic systems and associated control units available from Eaton, Hydraulics Business USA, Eden Prairie Minn., USA (see e.g., http://www.eaton.com/EatonCom/Markets/Hydraulics/index.htm).

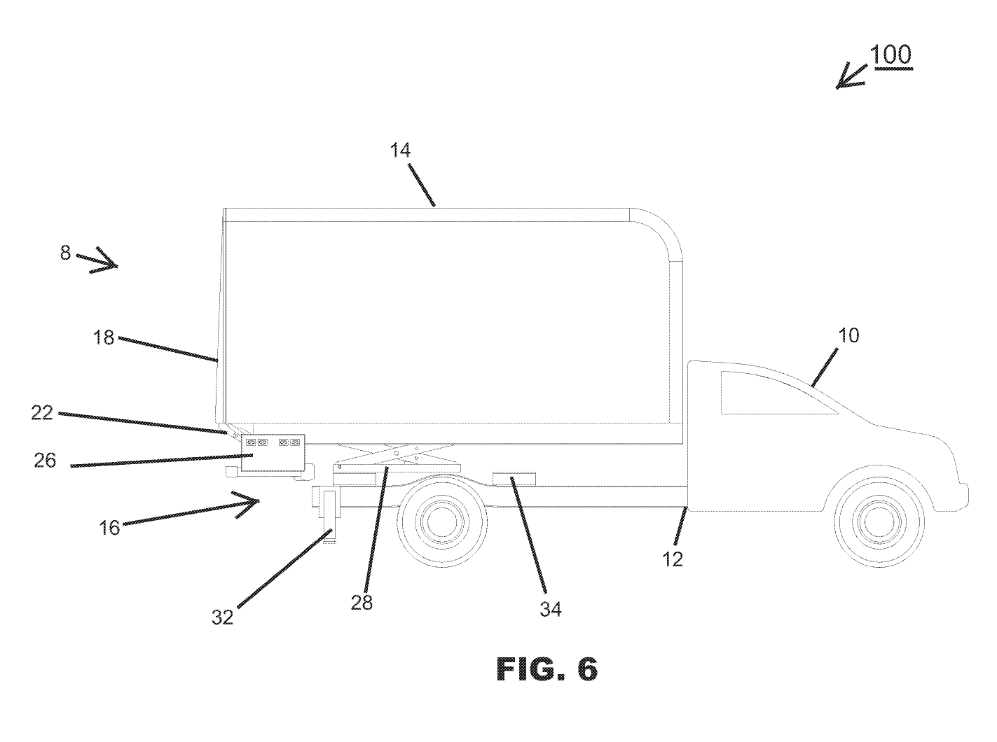

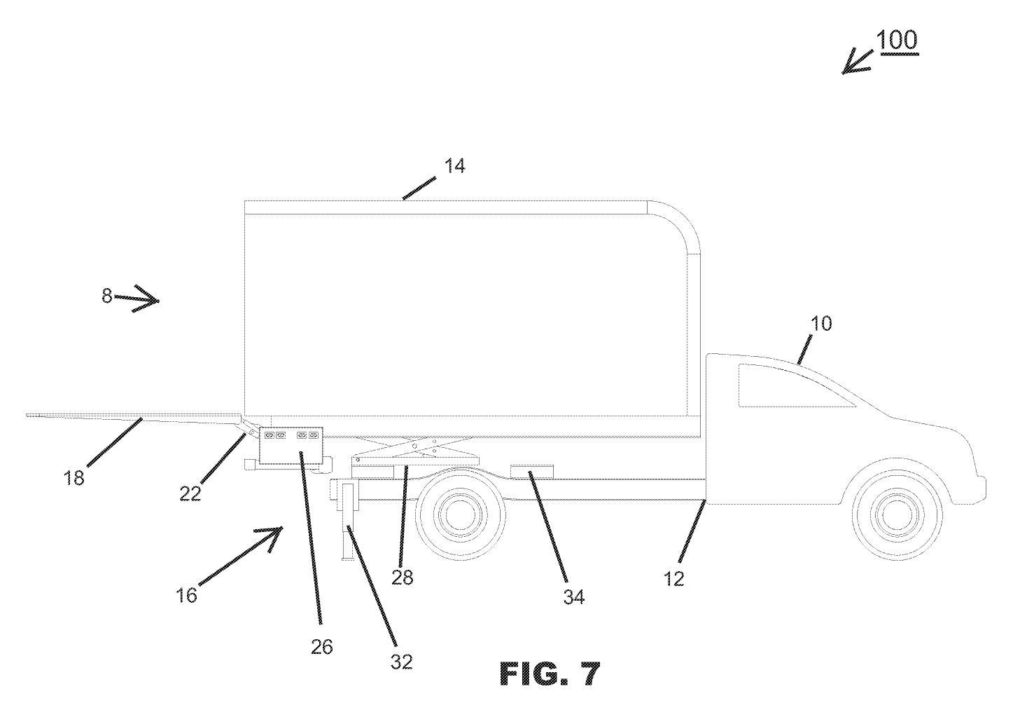

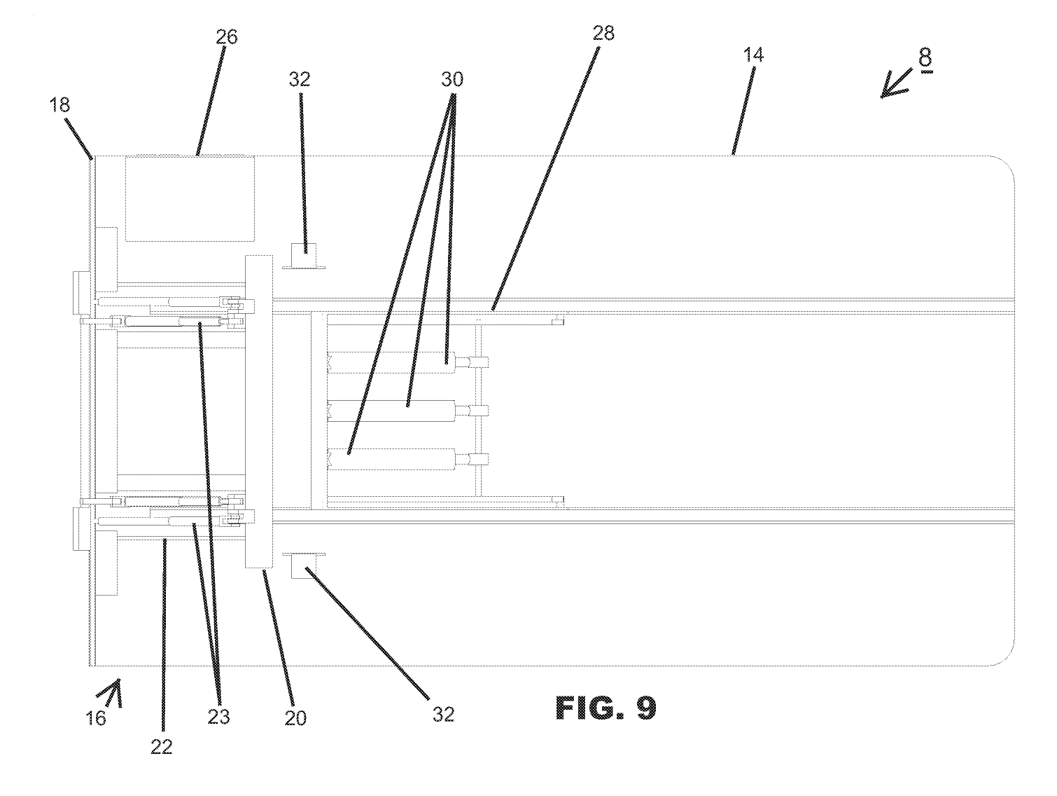

Referring now to FIGS. 6-8, in addition to the lift gate 18 being movable between various heights and positions, the entire cargo-carrying unit 14 may be elevated from the chassis cab 12 or cutaway chassis 12′ by means of a lifting mechanism, such as an extensible spacer mechanism 28 such as, for example, a scissor lift, that is a component of the lift frame 16 (a good portion of which is shown in FIG. 8). This feature may be particularly useful when the truck 12 is backed into a standard loading dock so that the height of the cargo-carrying unit 14 can be adjusted to the height of the dock. Similar to the lift gate movement mechanisms 22, the an extensible spacer mechanism 28 such as, for example, a scissor lift that may utilize pneumatic or hydraulic pistons 30, as shown in FIG. 9, for providing the force required to elevate the cargo-carrying unit 14 off the chassis cab 12 or cutaway chassis 12′ and then lower it back on the chassis cab 12 or cutaway chassis 12′. Examples of suitable scissor lifts include, without limitation, Part No. SHT-30000AL available from AHT, Gattendorf, Austria, EU (see e.g., http://www.aht-mhw.com/en/content/index.htm) and Hydraulic Scissor Lift Table, Part No. SLHS-15-36-6000-30-720BO available from Omni Metalcraft Corp., Alpena, Mich., USA (see e.g., http://www.omni.com/mypage.asp?home=/products/scissorlifts&template=product.htm& subset=LITERATURE). Other examples of possible scissor lifts may include, without limitation, 24S25DL, 24S40DL, 24S60DL, and 24S80DL series 35 double long scissors lifts available from Autoquip Corporation, Guthrie, Okla., USA (see e.g., http://www.autoquip.com); the scissor lift disclosed in U.S. Pat. No. 5,460,460 assigned on its face to 4Front Engineered Solutions, Carrollton, Tex., USA (http://serco.4frontes.com/). An operator may also activate the extensible spacer mechanism 28 such as, for example, a scissor lift, by invoking controls on the controller 26. Examples of a suitable controller 26 include, without limitation, the 8-button master control on the power pack controller available from AHT, Gattendorf, Austria, EU (see e.g., Power Packs at http://www.aht-mhw.com/en/content/index.htm). Other examples of possible controllers 26 may include, without limitation, hydraulic systems and associated control units available from Weber-Hydraulik GmbH, Losenstein, Austria, EU (see e.g., http://www.weber.de/hydraulik/en/html/kontakt-austria.php); hydraulic systems and associated control units available from Atlantic Industrial Technologies, Shirley, N.Y., USA (see e.g., http://www.aitzone.com/index.php); and hydraulic systems and associated control units available from Eaton, Hydraulics Business USA, Eden Prairie Minn., USA (see e.g., http://www.eaton.com/EatonCom/Markets/Hydraulics/index.htm).

As shown in the Figures, spacers 34 may be provided on each side of the chassis cab 12 or cutaway chassis 12′ to create a space between the top of the chassis cab 12 or cutaway chassis 12′ and the bottom of the cargo-carrying unit 14. Such space may accommodate the size of an extensible spacer mechanism 28 such as, for example, a scissor lift, even when the extensible spacer mechanism 28 is in a resting (non-elevated) position. For safety purposes, a cargo locking mechanism 38 may also be provided on the chassis cab 12 or cutaway chassis 12′ for locking the cargo-carrying unit 14 to the chassis cab 12 or cutaway chassis 12′ when the truck 10 is in motion. Examples of suitable locking mechanisms 38 include, without limitation, twistlock model 1101-2959, available from Buffers USA, Jacksonville, Fla., USA (see e.g., Twistlock & Pinlock Assemblies & Parts at http://www.buffersusa.com/parts2.php?type=part&groupid=1100) and Rotary Lock, model AH-450-LH available from Autohardware, Charlotte, N.C., USA. Other examples of possible locking mechanisms 38 may include, without limitation, type BLR and/or type ML twistlocks available from Krisry International, Inc., Weston, Ohio, USA (see e.g., http://krisryinc-com.netsolads.com/typesoftwistlocks.html); 182895 FM-QLTB Qwik-Load™ turnbuckles available from Happijac Company, Kaysville, Utah, USA (see e.g., http://www.happijac.com/prod-td/qwikload.php); and BL 7002 and/or BL 7003 lock and striker assemblies available from Wastequip Manufacturing Company (see e.g., US 2009/0095866) or Pioneer, a Wastequip Company, North Oxford, Mass., USA (see e.g., http://www.pioneercoverall.com/Container-Securement-34.htm).

As a way of providing additional safety and support for the motor vehicle configured for cargo transport 100 of the present invention, a support leg 32 may be disposed on each side of the chassis cab 12 or cutaway chassis 12′. Each support leg 32 may be configured to be raised from the ground surface when the truck 10 is in motion and then lowered to the ground, such that it may be disposed between the chassis cab 12 or cutaway chassis 12′ and the ground, when the lift gate 18 and/or an extensible spacer mechanism 28 such as, for example, a scissor lift, are in use. For example, each support leg 32 may include two or more sections in a telescopic engagement such that the enclosed sections of the support leg 32 may be housed within the other sections when the truck 10 is in motion and then lowered when the truck 10 is at rest. Examples of possible support leg 32 may include, without limitation, hydraulic landing gear available from Lippert Components, Inc., Goshen, Ind., USA (see e.g., http://www.lci1.com/OwnersManuals/Leveling/Hydraulic%20Landing%20Gear-Web.pdf); electric stabilizer jack kit available from Happijac Company, Kaysville, Utah, USA (see e.g., http://store.lci1.com/shared/StoreFront/default.asp?CS=lci&StoreType=BtoC&Count1=689998805&Count2=607139229&ProductID=67&Target=products.asp); heavy duty telescoping support leg available from Stronga Ltd, Bayford Nr Hertford, United Kingdom, EU (see e.g., http://www.agricultural-trailers.com/Technical/Agricultural-Trailer-Drawbar-Support-Legs.htm); and hydraulic drawbar leg available from Stronga Ltd, Bayford Nr Hertford, Hertfordshire, United Kingdom, EU (see e.g., http://www.agricultural-trailers.com/Technical/Agricultural-Trailer-Drawbar-Support-Legs.htm).

Referring now to exemplary manners of using a motor vehicle configured for cargo transport 100 and associated vehicle-mountable cargo transport apparatus 8 of the present invention, when the operator of a truck 10 desires to load heavy objects onto the cargo-carrying unit 14 from the ground surface, the operator may park the truck 10 and activate the lift gate 18 from the controller 26 to transition the lift gate 18 from its closed position to the second open tailgate position (as shown in FIGS. 1 and 5) such that the lift gate rests on or may be close to the ground surface, as shown in FIG. 5. Once the object is placed onto the lift gate 18, the operator may again activate the lift gate 18 from the controller 26 so that it may be elevated to the level of the bottom wall of the cargo-carrying unit 14 (the first open tailgate position), as shown in FIG. 4. The operator may then transfer the object from the lift gate 18 platform to the cargo-carrying unit 14. When the operator is ready to close the cargo-carrying unit 14, he or she may simply activate the lift gate 18 from the controller 26 to return it to the closed position, as shown in FIG. 2.

In another example, when the truck 10 operator desires to load objects into the cargo-carrying unit 14 from a loading dock, the operator may determine whether the height of the cargo-carrying unit 14 needs to be elevated to accommodate the height of the dock. If it is desirable to elevate the cargo-carrying unit 14, the operator may park the truck 10, lower the support legs 32, and release the locking mechanism 38 so that the cargo-carrying unit 14 is no longer locked to the chassis cab 12 or cutaway chassis 12′. The operator may then activate the an extensible spacer mechanism 28 such as, for example, a scissor lift, from the controller 26 to elevate the cargo-carrying unit 14 with respect to the chassis cab 12 or cutaway chassis 12′. Once at the desired height, the operator may activate the lift gate 18 to transition from its closed position to the first or second open tailgate positions (or any positions there between), as needed, to achieve the desired height and position of the lift gate 18.

The components comprising the lift frame 16 may be manufactured from lightweight, durable materials such as lightweight alloys (e.g. aluminum alloys . . . etc.) or may be manufactured as lightweight, durable structures such as conventional alloys (e.g. steel alloys . . . etc.) or composite materials (e.g., fiber reinforced polymer composite materials . . . etc.). Examples of suitable lightweight, durable materials for the lift frame 16 may include, without limitation, aluminum channel, item number 6061-T6AA-CH available from Yarde Metals, High Point, N.C. or a structural channel, item number 6061-T6 MF AA available from Eastern Metals, Charlotte, N.C., USA. Other examples of possible durable materials for the lift frame 16 may include, without limitation, those materials used in the manufacture of the other examples of possible lift gates 18 discussed above. Likewise, the components comprising the cargo-carrying unit 14 may be manufactured from lightweight, durable materials such as lightweight alloys (e.g. aluminum alloys . . . etc.) or may be manufactured as lightweight, durable structures such as conventional alloys (e.g. steel alloys . . . etc.) or composite materials (e.g., fiber reinforced polymer composite materials . . . etc.). Examples of suitable lightweight, durable materials for cargo-carrying unit 14 may include, without limitation, NYLOBOARD™ engineered nylon composite board made from recycled carpet fibers and VOC-free bonding resins available from Nyloboard, LLC Covington, Ga., USA (see e.g., Sheet Goods http://nyloboard.com/products). Other examples of possible lightweight, durable materials for cargo-carrying unit 14 may include, without limitation, materials used for the manufacture of associated panels, associated apparatuses, and/or associated methods as taught in U.S. Pat. No. 7,500,563 assigned on its face to Transportation Systems Solutions LLC, High Point, N.C., USA (see e.g., http://trailer-bodybuilders.com/mag/trucks_body_manufacturer_turns/) and materials used for the manufacture of composite panels, associated apparatuses, and associated methods as taught in U.S. Pat. No. 6,742,974 assigned on its face to Transportation Systems Solutions LLC, High Point, N.C., USA (see e.g., http://trailer-bodybuilders.com/mag/trucks_body_manufacturer turns/), the disclosure and subject matter of each being herein incorporated by reference in their entirety.

In one embodiment of the present invention, the total GVWR of the motor vehicle configured for cargo transport 100 (including truck 12, the cargo-carrying unit 14, the lift gate 18, the lift frame 16, and any cargo) may be less than 10,000 pounds so that a person may operate the truck 10 without requiring a CDL. In another embodiment of the present invention, the GVWR of the motor vehicle configured for cargo transport 100 (including truck 12, the cargo-carrying unit 14, the lift gate 18, the lift frame 16, and any cargo) may be less than 10,000 pounds while at the same time cargo up to about 2,000 pounds or more may be transported.

In summary, the a motor vehicle configured for cargo transport and associated vehicle-mountable cargo transport apparatus of the present invention provides operators of box trucks with the flexibility of adjusting height of the cargo box and the height and position of the cargo box door to accommodate various loading positions. While operators of typical box trucks having a GVWR of less than 10,000 pounds are unable to load and unload cargo from commercial loading docks because the trucks are too low, the cargo transport of the present invention enables adjustment of the height and position of the cargo-carrying units for such smaller cargo to accommodate standard loading docks. Thus, the operators of such smaller box trucks (less than 10,000 pounds GVWR) are able to use such trucks for commercial cargo transport without requiring a CDL.

Other than in the operating examples, or where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by an aspect of an embodiment and/or embodiments of the present invention. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting forth the broad scope of the invention are approximations, the numerical values set forth in the specific examples are reported as precisely as possible. Any numerical values, however, inherently contain certain errors necessarily resulting from the standard deviation found in their respective testing measurements.

The functions of the various elements shown in the FIGS. 1 through 9 would, in aspects of embodiments and/or embodiments be implemented by one or more controllers, linkages, pistons, screws, gates, or the like rather than individual hardware elements. Thus, in the claims hereof any element expressed as a means for performing a specified function is intended to encompass any way of performing that function including, for example: (a) a combination of electrical elements, mechanical elements, and/or hydraulic elements which performs that function or (b) software in any form (including, therefore, firmware, microcode or the like) combined with appropriate processors and/or computers for executing that software and electrical elements, mechanical elements, and/or hydraulic elements to perform the function. Thus, it will be appreciated that applicant regards any elements capable of performing particular functions recited in the claims as being equivalent to those disclosed herein.

While several embodiments have been described in detail herein, it will be apparent to those skilled in the art that the disclosed embodiments may be modified. Therefore, the foregoing description is to be considered exemplary and is not intended to limit the invention to these embodiments. On the contrary, the invention is intended to cover alternatives, modifications and equivalents, which may be included within the spirit and scope of the invention as defined by the appended claims. For example, the vehicle-mountable cargo transport apparatus as described above is not limited to the described cargo-carrying unit. Rather, any suitable cargo-carrying unit configured for facilitating the integrity of a cargo for its delivery while at the same time being configured for association with a motor vehicle so that the motor vehicle has a gross vehicle weight rating (GVWR) up to about 10,000 lbs, and may be capable of transporting a cargo up to about 3,500 lbs or more, may be utilized. For example, it will appreciated that while the motor vehicle may have a gross vehicle weight rating (GVWR) up to about 10,000 lbs, that such GVWR may be less, such as, for example, as low as about 6,500 lbs or less. Likewise, it will appreciated that any GVWR between about 6,500 lbs or less and not exceeding about 10,000 lbs is contemplated. Also, it will appreciated that while the motor vehicle may be capable of transporting a cargo up to about 3,500 lbs or more, that such capable may be less, such as, for example, as low as about 1,500 lbs or less. Likewise, it will appreciated that any a cargo weight between none and up to about 3,500 lbs or more is contemplated. It should be understood that all such modifications and improvements have been deleted herein for the sake of conciseness and readability but are properly within the scope of the following claims.

Furthermore, in the detailed description of the present invention, numerous specific details are set forth in order to provide a thorough understanding of the present invention. In other instances, well-known methods, procedures, components, and circuits have not been described in detail as not to unnecessarily obscure aspects of the present invention. However, it will be recognized by one of ordinary skill in the art that the present invention may be practiced without these specific details.

What is claimed is:

1. An article comprising a motor vehicle:
a. configured for transporting a cargo up to about 3,500 lbs;
b. having a gross vehicle weight rating (GVWR) up to about 10,000 lbs;
c. including a chassis cab or cutaway chassis;
d. including a cargo-carrying unit configured for:
i. at least one of receiving and delivering a cargo at a conventional loading dock,
ii. at least the other of receiving and delivering the cargo at street level,
iii. both receiving and delivering a cargo at a conventional loading dock,
iv. both receiving and delivering the cargo at street level, or
v. combinations thereof; and
e. an extensible spacer mechanism for reversibly increasing a distance of the cargo-carrying unit with respect to the ground so as to accommodate the at least one of receiving and delivering of the cargo at a conventional loading dock.

2. The article according to claim 1, wherein the cargo-carrying unit further comprises one or more securing elements that facilitate securing the cargo within the cargo-carrying unit so as to maintain the cargo's integrity for delivery.

3. The article according to claim 1, further comprising a lift gate configured for transitioning from a closed position to one or both of (α) a first open position and (β) a second open position, and vice versa, wherein when the lift gate is in the:
i. closed position, the lift gate is substantially vertically disposed as a detachable end wall of the cargo-carrying unit;
ii. first open position, the lift gate is horizontally disposed such that the lift gate is about level with a floor of the of the cargo-carrying unit; and
iii. second open position, the lift gate is substantially horizontally disposed such that the lift gate is substantially parallel with a floor of the of the cargo-carrying unit in a plane lower than the floor of the of the cargo-carrying unit.

4. The article according to claim 3, wherein one or more pistons comprising any one of:
i. one or more hydraulic pistons,
ii. one or more pneumatic pistons, or
iii. combinations thereof
facilitate the transitioning of the lift gate from the closed position to one or both of the (α) a first open position and (β) a second open position, and vice versa.

5. The article according to claim 1 wherein the extensible spacer mechanism comprises a scissor lift that facilitates reversibly increasing the distance of the cargo-carrying unit with respect to the ground by reversibly increasing the distance of the cargo-carrying unit with respect to the chassis cab or cutaway chassis.

6. The article according to claim 1, wherein the extensible spacer mechanism further comprises any one of:
i. one or more linkages,
ii. one or more screws,
iii. one or more hydraulic pistons,
iv. one or more pneumatic pistons, or
v. combinations thereof
facilitate reversibly increasing the distance of the cargo-carrying unit with respect to the ground so as to accommodate the at least one of receiving and delivering of cargo at a conventional loading dock.

7. The article according to claim 1, further comprising a controller configured for at least operating the extensible spacer mechanism and in fluid communication with one or more of the following hydraulic pumps:
i. an electrically driven pump;
ii. a power take off (PTO) driven pump;
iii. clutch actuated pump; or
iii. combinations thereof.

8. The article according to claim 7, further comprising one or more safety interlocks in communication with the controller, the one or more safety interlocks configured for preventing the operation of at least the extensible spacer mechanism under one or more of the following conditions:
i. the movement of the motor vehicle;
ii. a non-extension of at least one support leg configured for stabilizing any one of the motor vehicle, the chassis cab or cutaway chassis, the vehicle-mountable cargo transport apparatus, the cargo-carrying unit, or combinations thereof during an operation of the extensible spacer mechanism; or
iii. combinations thereof.

9. The article according to claim 1, further comprising at least one support leg configured for stabilizing any one of the motor vehicle, the chassis cab or cutaway chassis, the vehicle-mountable cargo transport apparatus, the cargo-carrying unit, or combinations thereof during an operation of the extensible spacer mechanism.

10. The article according to claim 1, further comprising a locking mechanism configured for releasably locking the cargo-carrying unit to any one of the motor vehicle; the chassis cab or cutaway chassis or both.

11. The article according to claim 1, further comprising one or more spacers attached to any one of the motor vehicle, the chassis cab or cutaway chassis, the vehicle-mountable cargo transport apparatus, the cargo-carrying unit, or combinations thereof to accommodate the cargo-carrying unit lifting mechanism.

12. An article comprising a vehicle-mountable cargo transport apparatus configured for association with a motor vehicle so that the motor vehicle has a gross vehicle weight rating (GVWR) up to about 10,000 lbs and is capable of transporting a cargo up to about 3,500 lbs, the vehicle-mountable cargo transport apparatus:
a. configured for:
i. at least one of receiving and delivering a cargo at a conventional loading dock,
ii. at least the other of receiving and delivering the cargo at street level,
iii. both receiving and delivering a cargo at a conventional loading dock,
iv. both receiving and delivering the cargo at street level, or
v. combinations thereof;
b. including a cargo-carrying unit; and
c. an extensible spacer mechanism for reversibly increasing a distance of the cargo-carrying unit with respect to the ground so as to accommodate the at least one of receiving and delivering of cargo at a conventional loading dock.

13. The article according to claim 12, wherein the cargo-carrying unit further comprises one or more securing elements that facilitate securing the cargo within the cargo-carrying unit so as to maintain the cargo's integrity for delivery.

14. The article according to claim 12, further comprising a lift gate configured for transitioning from a closed position to one or both of (α) a first open position and (β) a second open position, and vice versa, wherein when the lift gate is in the:
i. closed position, the lift gate is substantially vertically disposed as a detachable end wall of the cargo-carrying unit;
ii. first open position, the lift gate is horizontally disposed such that the lift gate is about level with a floor of the of the cargo-carrying unit; and
iii. second open position, the lift gate is substantially horizontally disposed such that the lift gate is substantially parallel with a floor of the of the cargo-carrying unit in a plane lower than the floor of the of the cargo-carrying unit.

15. The article according to claim 14, wherein one or more pistons comprising any one of:
i. one or more hydraulic pistons,
ii. one or more pneumatic pistons, or
iii. combinations thereof
facilitate the transitioning of the lift gate from the closed position to one or both of the (α) a first open position and (β) a second open position, and vice versa.

16. The article according to claim 12 wherein the extensible spacer mechanism comprises a scissor lift that facilitates reversibly increasing the distance of the cargo-carrying unit with respect to the ground by reversibly increasing the distance of the cargo-carrying unit with respect to a chassis cab or cutaway chassis of a motor vehicle.

17. The article according to claim 12, wherein the extensible spacer mechanism further comprising any one of:
i. one or more linkages,
ii. one or more screws,
iii. one or more hydraulic pistons,
iv. one or more pneumatic pistons, or
v. combinations thereof
facilitates reversibly increasing the distance of the cargo-carrying unit with respect to the ground so as to accommodate the at least one of receiving and delivering of cargo at a conventional loading dock.

18. The article according to claim 12, further comprising a controller configured for at least operating the extensible spacer mechanism and configured for fluid communication with one or more of the following hydraulic pumps:
i. an electrically driven pump;
ii. a power take off (PTO) driven pump;
iii. clutch actuated pump; or
iii. combinations thereof.

19. The article according to claim 18, further comprising one or more safety interlocks in communication with the controller, the one or more safety interlocks configured for preventing the operation of at least the extensible spacer mechanism under one or more of the following conditions:
i. the movement of the motor vehicle;
ii. a non-extension of at least one support leg configured for stabilizing any one of the motor vehicle, the chassis cab or cutaway chassis, the vehicle-mountable cargo transport apparatus, the cargo-carrying unit, or combinations thereof during an operation of the extensible spacer mechanism; or
iii. combinations thereof.

20. The article according to claim 12, further comprising at least one support leg configured for stabilizing any one of the motor vehicle, the chassis cab or cutaway chassis, the vehicle-mountable cargo transport apparatus, the cargo-carrying unit, or combinations thereof during an operation of the extensible spacer mechanism.

21. The article according to claim 12, further comprising a locking mechanism configured for releasably locking the cargo-carrying unit to any one of the motor vehicle; the chassis cab or cutaway chassis, or both.

22. The article according to claim 12, further comprising one or more spacers configured for attachment to any one of the motor vehicle, the chassis cab or cutaway chassis, the vehicle-mountable cargo transport apparatus, the cargo-carrying unit, or combinations thereof to accommodate the cargo-carrying unit lifting mechanism.

23. A method of using a vehicle-mounted cargo transport apparatus comprising a cargo-carrying unit and associated with a motor vehicle so that the motor vehicle has a gross vehicle weight rating (GVWR) up to about 10,000 lbs and is capable of transporting a cargo up to about 3,500 lbs, the method comprising the steps of:
a. reversibly elevating the cargo-carrying unit; and
b. reversibly transitioning a lift gate associated with the cargo-carrying unit from a closed position to one or both of (α) a first open position and (β) a second open position, and vice versa, wherein when the lift gate is in the:
i. closed position, the lift gate is substantially vertically disposed as a removable end wall for the cargo-carrying unit;
ii. first open position, the lift gate is substantially horizontally disposed such that the lift gate is about level with a floor of the cargo-carrying unit; and
iii. second open position, the lift gate is substantially horizontally disposed such that the lift gate is substantially parallel to the floor of the cargo-carrying unit in a plane lower than the floor of the cargo-carrying unit.

24. The method according to claim 23, wherein comprising securing, unsecuring, or securing and unsecuring a cargo within the cargo-carrying.

25. The method according to claim 23, wherein the transitioning of the lift gate from the closed position to one or both of the (α) first open position and (β) second open position, and vice versa comprises using one or more pistons comprising any one of:
i. one or more hydraulic pistons,
ii. one or more pneumatic pistons, or
iii. combinations thereof.

26. The method according to claim 23, wherein the reversibly increasing the distance of the cargo-carrying unit with respect to the ground comprises reversibly increasing the distance of the cargo-carrying unit with respect to a chassis cab or cutaway chassis of the motor vehicle.

27. The method according to claim 23, wherein the reversibly increasing the distance of the cargo-carrying unit with respect to the ground comprises using any one of:
i. one or more linkages,
ii. one or more screws,
iii. one or more hydraulic pistons,
iv. one or more pneumatic pistons, or
v. combinations thereof.

28. The method according to claim 23, wherein the reversibly increasing the distance of the cargo-carrying unit with respect to the ground comprises operating a controller in fluid communication with one or more of the following hydraulic pumps:
i. an electrically driven pump;
ii. a power take off (PTO) driven pump;
iii. clutch actuated pump; or
iii. combinations thereof.

29. The method according to claim 28, further comprising using one or more safety interlocks in communication with the controller so as to prevent reversibly increasing the distance of the cargo-carrying unit with respect to the ground under one or more of the following conditions:
i. the movement of the motor vehicle;
ii. a non-extension of at least one support leg configured for stabilizing any one of the motor vehicle, the chassis cab or cutaway chassis, the vehicle-mountable cargo transport apparatus, the cargo-carrying unit, or combinations thereof during an operation of the extensible spacer mechanism; or
iii. combinations thereof.

30. The method according to claim 23, further comprising stabilizing any one of the motor vehicle, a chassis cab or cutaway chassis, the vehicle-mountable cargo transport apparatus, the cargo-carrying unit, or combinations thereof during the reversible increasing of the distance of the cargo-carrying unit with respect to the ground by providing at least one support leg.

31. The method according to claim 23, further comprising unlocking the cargo-carrying unit from any one of the motor vehicle; a chassis cab or cutaway chassis or both prior to reversibly increasing of the distance of the cargo-carrying unit with respect to the ground.
